(19) United States
(12) Patent Application Publication
(10) Pub. No.: US 2007/0051205 A1
(43) Pub. Date: Mar. 8, 2007

(54) Cork-screw with double propping lever

(76) Inventors: Daniele Farfalli, Maniago (PN) (IT); Gianluigi Fortunato, Creazzo (VI) (IT)

Correspondence Address: ST. ONGE STEWARD JOHNSTON & REENS, LLC, 986 BEDFORD STREET, STAMFORD, CT, 06905-5619, US

(21) Appl. No.: 11/486,917

(22) Filed: Jul. 14, 2006

Related U.S. Application Data
(63) Continuation of application No. PCT/IT05/00011, filed on Jan. 12, 2005.

(30) Foreign Application Priority Data
Jan. 15, 2004 (IT) UD2004A000004

(51) Int. Cl. B67B 7/00

(52) U.S. Cl. 81/3.45; 81/3.36

(57) ABSTRACT

Cork-screw with double propping lever, with an adjacent extraction cork-screw, in which the double propping lever presents a first base lever hinged which one end to the handle of the tool, and a second extension lever for the propping hinged at the end of said first base lever, whereby said second extension lever for the propping presents two propping support teeth, one support teeth at the end and one support teeth close to its articulation to the print base lever.

### CROSS-REFERENCE TO RELATED APPLICATIONS

The present application is a continuation of pending International patent application PCT/IT2005/000011 filed on Jan. 12, 2005 which designates the United States and claims priority from Italian patent application UD2004A000004 filed on Jan. 15, 2004, the content of which is incorporated herein by reference.

### FIELD OF THE INVENTION

This invention relates to an improved cork-screw with double propping lever according to the preamble of the main claim.

### BACKGROUND OF THE INVENTION

The cork-screw of the present innovation is of the pocket type with switchblade particularly suitable for the extraction of plugs from bottles and for the extraction of crown caps.

Cork-screws of this type are well-known indeed in many forms and configurations, as per FR-A-2689115; U.S. Pat. No. 4,437,359; US-A1-2002/157188; EP-A-1350756.

Among the many configurations the cork-screw FR2689115 is known, with, in the support propping lever for the neck of the bottle, instead of a single propping lever, a lever subdivided in arm (5) and forearm (13), in which in the arm internally a hook (7) is provided for taking away the crown caps and over this a support tooth and bottle neck propping (8) for a first extraction of the plug and, with end pivoting (14), a second extension lever or forearm (13) with a second support tooth for propping for completing the extraction of the plug (15).

This solution is thus particularly advantageous for the extraction, with the help of the screw or corkscrew spiral (3), of caps from bottles also when they are partially extracted by means of the action with the first lever (5) for facilitating the completion of the extraction, precisely by means of the second openable lever (13).

Drawbacks of this earlier solution substantially consist in the impairment of the support tooth (8) because of the appendix (9) that, during extraction comes into contact with the border of the bottle trying to drag outwards the tooth (8). In fact during the extraction, for a vertical exit of the cap, the propping lever must perforce tilt. At the start it is pratically parallel to the spiral, after having extracted about 1 centimeter of the cap it is inclined and therefore the appendix (9) hits the border of the bottle and drags the support tooth (8) outwards. Repeating the operation several times the support tooth (8) blunts and does not guarantee anymore the propping on the border of the bottle.

In fact the difficulty of incipient extraction of the cap is known, due to excessive approach or remoteness of the propping lever (5) from the cork-screw.

In fact it is well known that during the operation of the lever, as the lever handle must unavoidably tilt as to the axis of the bottle, the distance between the propping lever and the extraction lever (cork-screw) varies.

To solve this problem many solutions have been conceived, among which the variation with cam of the pivoting axis of one or the other lever (6) and/or (4).

These solutions however involve a considerable complexity of construction and therefore high realization costs.

Therefore if the second support in the propping lever extension (15) can adjust better in the distance, certainly the first cannot, so the problem of a maximum perfect functionality still remains.

The aim of the present invention is to avoid the above-mentioned drawbacks, realizing a much more versatile and functional pocket cork-screw, however at a reasonable cost.

### SUMMARY OF THE INVENTION

The problem is solved with the characteristics of main claim.

The subclaims represent particularly advantageous solutions.

With this solution, thanks to the positioning of both support teeth for propping on the extension lever, the support teeth, in particular no. (33), do not graze anymore on the border of the bottle because of the tilt of the propping lever, but remain fixed and without transverse movements, therefore maintaining their form for a long time without blunting and thus without fastidious hooking losses.

### BRIEF DESCRIPTION OF THE DRAWINGS

This invention will be now better understood with the help of the enclosed FIGURE including:

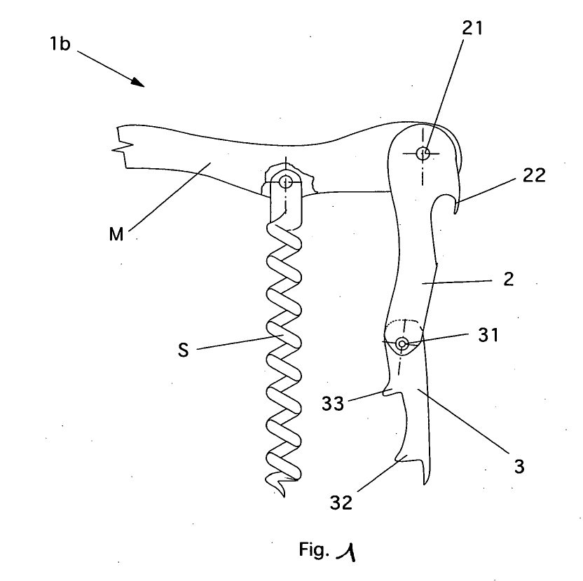

In FIG. 1 the position of the lever extension slightly rotated towards the back and therefore with better propping safety and easier propping for both support teeth and greater variability in selfadjusting of the distance with the cork-screw according to the present invention.

### DETAILED DESCRIPTION OF THE INVENTION

According to the FIGURE it is observed that with (1b) the position of the lever extension (3) is indicated slightly refolded to the contrary, namely outwards as to the respective end pivot (31) on the base lever arm (2) which in turn presents the crown caps opening hook (22) placed outside and applied near the pivoting base (21) at the handle (m).

The extraction cork-screw (5) is carried out according to prior art and according to the invention both support teeth for propping (32, 33) are applied internally on the lever extension (3).

In this way a complete self-regulation of the distance between said propping abutments (323,33) with respective lever extension (3) thanks to the articulation (31) in association with the articulation of the base propping lever (21) is obtained.

Naturally the cork-screw is represented here only for the part of the extraction side, the other part can be realised as desired, namely with little knives, with or without other tools etc.

Advantageously inside the handle and between said first propping lever and extension lever traditional cutting means can be provided, e. g. with wheels, for the coating the neck of the bottle according to prior art.

What is claimed is:

1. Cork-screw with double propping lever, associated to an adjacent extraction cork-screw, in which the double propping lever presents a first base lever hinged to the handle of the tool, and a second extension lever for the propping hinged at the end of said first base lever, characterised in that said second extension lever for propping internally presents two propping support teeth, one at end and one more closed to its respective hinge and wherein said first base lever presents a hook applied outside and near the respective base pivoting.

2. Cork-screw according to claim 1, characterised in that the pivoting articulation of said second extension lever for propping is such as to allow an opening with slight outwards angulation namely beyond 180° of rectilinearity.

3. Cork-screw according to claim 1, characterised in that said first base lever presents a hook applied outside and near the respective base pivoting, for the opening by means of hooking crown caps, cork caps and leverism closed near the handle.

4. Cork-screw according to claim 1, characterised by disposing, inside the handle between said cork-screw and between said first propping lever and first extension lever, cutting or incision means for coating the neck of the bottle.
